(19) United States
(12) Patent Application Publication
(10) Pub. No.: US 2008/0210205 A1
(43) Pub. Date: Sep. 4, 2008

(54) Hydraulic Control Type Supercharger for Automotive Engine

(76) Inventor: Jung-Ho Baek, Busan (KR)

Correspondence Address: SHERR & NOURSE, PLLC, 620 HERNDON PARKWAY, SUITE 200, HERNDON, VA, 20170, US

(21) Appl. No.: 11/994,986

(22) PCT Filed: Jul. 5, 2006
(86) PCT No.: PCT/KR2006/002628

§ 371 Date: Jan. 7, 2008

(30) Foreign Application Priority Data
Jul. 8, 2005 (KR) 10-2005-0061875

(51) Int. Cl. F02B 33/40; F04B 17/04

(52) U.S. Cl. 123/565; 417/417

(57) ABSTRACT

Disclosed herein is a hydraulic control type supercharger for an automotive engine. The supercharger includes a supercharger unit and a solenoid pump. The supercharger unit includes a hollow housing inserted into an intake pipe and having a longitudinal hollow portion, a rotating shaft mounted to the hollow housing to pass through the hollow portion thereof, an impeller rotating along with the rotating shaft, and an intake fan rotating along with the rotating shaft which is rotated by injecting oil into the impeller. The solenoid pump is coupled to an oil inlet passage of the supercharger unit, and is operated in response to an electric signal.

### TECHNICAL FIELD

The present invention relates, in general, to a supercharger for automotive engines and, more particularly, to a hydraulic control type supercharger for automotive engines, which pressurizes air flowing into an engine or discharged from the engine using oil supplied from an oil pump, thus improving the output of the engine and fuel efficiency.

### BACKGROUND ART

A supercharger of an engine is a device which is used to increase the output from an automobile without increasing the displacement of the engine. The supercharger is installed between an intake pipe for drawing external air into the engine and a discharge pipe for discharging air from the engine. The supercharger pressurizes the air drawn into the engine such that the air pressure is higher than atmospheric pressure, thus improving the efficiency with which mixture gas is fed into the engine, thereby increasing the output of the engine.

Further, the supercharger is typically classified into a turbocharger method and a supercharger method. According to the turbocharger method, a turbine is rotated using the kinetic energy of exhaust gas discharged from the discharge pipe of the engine, and a compressor provided in the intake pipe, which is coaxially coupled to the turbine, is rotated, so that intake air is pressurized. Meanwhile, according to the supercharger method, intake air is pressurized by a compressor which is directly coupled to a crank shaft of the engine and is driven.

However, the turbocharger method uses the kinetic energy of the exhaust gas of the engine. Thus, in the case where the RPMs of the engine are high, a turbine having high strength and durability is required in order to sufficiently withstand the high heat and pressure of the exhaust gas. Further, it is not easy to control the compression ratio. Thus, in the case of a gasoline engine, spontaneous ignition may occur due to an excessive compression ratio, before the engine is ignited by a spark plug, so that knocking may undesirably occur. Conversely, in the case where the RPMs of the engine are low, the turbine is not operated. The supercharger method can be conducted even when RPMs are low, However, the supercharger method is problematic in that it directly consumes the output of the engine.

In order to solve the problems, a turbocharger for engines using hydraulic pressure was proposed in Korean Patent No. 10-151469. The turbocharger will be described below with reference to FIG. 1.

According to the above patent, the hydraulic turbocharger cools and compresses intake air using oil which is forcibly fed from a hydraulic pump 8c of a power steering system. The turbocharger is provided with a first port 2a and a third port 3a, into which oil discharged from a steering gearbox 1a flows, and a second port 4a and a fourth port 5a, from which the oil is discharged. The turbocharger includes a flow control valve 8a, a hydraulic motor 2b, an air radiator 5b, and a control unit 8b. A spool valve 7a biased by a spring 6a is mounted to the flow control valve 8a. The hydraulic motor 2b drives a blowing fan 1b using oil fed from the fourth port 5a of the flow control valve 8a through a first hydraulic line 9a to the hydraulic motor 2b. The air radiator 5b cools air fed through an intake port 3b by the rotation of the blowing fan 1b, and subsequently supplies the air to an intake chamber 4b. The control unit 8b controls a cooling motor 6b mounted to the air radiator 5b and a solenoid valve 7b mounted to the flow control valve 8a, based on the temperature of air discharged from the air radiator, the vehicle speed, and the RPMs of the engine.

The turbocharger constructed as described above uses oil which is forcibly fed by the hydraulic pump 8c driven by an engine 9b and passes through the steering gearbox 1a. The flow control valve 8a controlled by the solenoid valve 6b simply opens or closes a passage connected to the hydraulic motor 2b. Thus, the pressure of the oil is primarily reduced while the oil passes through the steering gearbox 1a. The pressure of the oil is secondarily reduced by opening or closing the flow control valve 8a. Thus, the oil cannot sufficiently operate the hydraulic motor 2b, which has no additional pressurizing means. Further, the pressure of the oil is changed depending on the output of the engine 9b, so that the blowing fan 1b operated by the hydraulic motor 2b is not sufficiently driven. Especially when the output of the engine is low, it is difficult to achieve sufficient turbo-charging performance.

In order to solve the problems, a turbocharger for an engine, which does not use oil in a hydraulic pump but uses oil directly fed from an oil pump mounted to an engine, was proposed by the same inventor and is disclosed in Korean Patent Laid-Open Publication No. 2003-71666. The turbocharger is shown in FIG. 2.

Referring to FIG. 2, the turbocharger includes a first turbocharger unit 10c, a first oil supply pipe 5c, a first oil discharge pipe 6c, and a compression fan 7c. The first turbocharger unit 10c is provided with an intake fan 3c and a first impeller 4c. The intake fan 3c is installed in an intake pipe 1c of the engine, and is mounted to a rotating shaft 2c to supply external air to the engine. The first impeller 4c is mounted to the rotating shaft 2c of the intake fan 3c to rotate along with the intake fan 3c. The first oil supply pipe 5c couples the oil pump to the intake pipe 1c so as to spray oil on the first impeller 4c. The first oil discharge pipe 6c couples the intake pipe 1c to the engine so as to supply the oil injected on the first impeller 4c to the engine. The compression fan 7c is further mounted to the rotating shaft 2c to be located behind the intake fan 3c. Thus, the intake fan 3c, the impeller 4c, and the compression fan 7c rotate together. Further, bearings 8c are provided, respectively, in front of and in back of the first impeller 4c mounted to the rotating shaft 2c of the intake fan 3c. A first bearing oil supply pipe 8d is installed to couple the oil pump to the first turbocharger unit 10c, and supplies oil to each of the bearings 8c.

Further, a second turbocharger unit, having the same construction as the first turbocharger unit 10c, is additionally mounted to a discharge pipe of the engine, and forcibly discharges exhaust gas, thus enabling the smooth flow of gas.

However, the intake fan 3c and the compression fan 7c perform different functions. That is, the intake fan 3c functions to draw air, whereas the compression fan 7c functions to compress the drawn air and prevent the backflow of the air. Thus, the rotating speed of the intake fan should be different from that of the compression fan. However, since the intake fan and the compression fan are mounted to the same rotating shaft 2c, it is impossible for the intake fan and the compression fan to rotate at different speeds.

Further, no pressurizing means or control means is provided to control the pressure of oil rotating the impeller 4c or the rotating speed. Thus, the impeller 4c is rotated only by oil pressure, which is variably generated in the oil pump depending on the output of the engine. Consequently, a sufficient turbo-charging effect is not achieved when the output of the engine is low. Further, an additional oil supply line is required to supply oil to each bearing 8c of the rotating shaft 2c.

Therefore, there is a great demand for a supercharger for engines, which is constructed so that the intake fan 3c and the compression fan 7c can rotate at different rotating speeds, and which includes a pressurizing means that is not directly coupled to an engine output shaft but is independently controlled, thus being driven suitably according to the engine output or acceleration conditions.

### DETAILED DESCRIPTION OF PRESENT INVENTION

Accordingly, the present invention has been made keeping in mind the above problems occurring in the prior art, and an object of the present invention is to provide a hydraulic control type supercharger for automotive engines, which is capable of individually controlling the operation of drawing external air into an engine and the operation of compressing the air.

Another object of the present invention is to provide a hydraulic control type supercharger for automotive engines, having a pressurizing means which does not directly depend on the output of an engine but can be independently controlled when the pressurizing means pressurizes oil fed into the supercharger.

A further object of the present invention is to provide a hydraulic control type supercharger for automotive engines, having a discharge promoter which is individually controlled using oil pressure so as to smoothly discharge exhaust gas from an engine.

The above and other objects, features and advantages of the present invention will be more clearly understood from the following detailed description taken in conjunction with the accompanying drawings. The terms or words in the specification and claims have been selected to most easily describe the invention, and may be changed without departing from the spirit and scope of the invention.

In order to accomplish the objects, the present invention provides a hydraulic control type supercharger for an automotive engine for forcibly blowing external air fed into an engine 400 using hydraulic pressure of oil discharged from an oil pump mounted to the engine 400, the supercharger including a supercharger unit 100 which has a hollow housing 10 inserted into an intake pipe and having a longitudinal hollow portion, a rotating shaft 12 mounted to the hollow housing to pass through the hollow portion thereof, an impeller 15 rotating along with the rotating shaft 12, an oil inlet passage 31 and an oil outlet passage provided in the hollow housing 10 to inject oil into the impeller 15 and discharge the injected oil, and an intake fan 14 rotating along with the rotating shaft 12; and a solenoid pump 200 coupled to the oil inlet passage 31 of the supercharger unit 100, and operated in response to an electric signal, wherein the operation of the solenoid pump 200 is variably controlled according to driving conditions of a vehicle, and oil, pressurized by the solenoid pump, is injected through the oil inlet passage 31 to rotate the impeller 15, thus controlling a rotating speed of the intake fan 14, therefore controlling supercharging performance of the supercharger unit 100.

The hydraulic control type supercharger further includes a compression fan rotating along with the rotating shaft of the supercharger unit.

Further, the present invention provides a hydraulic control type supercharger of an automotive engine for forcibly blowing external air fed into an engine 400 using hydraulic pressure of oil discharged from an oil pump mounted to the engine 400, the supercharger including a supercharger unit 100 which has a hollow housing 10 inserted into an intake pipe and having a longitudinal hollow portion, a first rotating shaft 12 and a second rotating shaft 12 mounted on an upstream side and a downstream side with respect to external air, respectively, to pass through the hollow portion of the hollow housing 10, an intake fan 14 and a first impeller 15 mounted to a first end and a second end of the first rotating shaft 12, respectively, a second impeller 15 and a compression fan 14 mounted to a first end and a second end of the second rotating shaft 12, respectively, and a first oil inlet passage 31, a second oil inlet passage 31, and an oil outlet passage provided in the hollow housing 10 for injection of oil to the first and second impellers 15 and discharge of the injected oil; and a solenoid pump 200 coupled to each of the first oil inlet passage 31 and the second oil inlet passage 31 of the supercharger unit 100, and operated in response to an electric signal, wherein the operation of the solenoid pump 200 is variably controlled according to driving conditions of a vehicle, and oil, pressurized by the solenoid pump, is injected through the oil inlet passage 31 to rotate the impeller 15, thus controlling a rotating speed of the intake fan 14, therefore controlling supercharging performance of the supercharger unit 100.

The solenoid pump 200 includes a hollow valve housing 21 around which an induction coil is wound, a spring 26 installed in the valve housing 21, a hollow moving spindle 27 coupled at a side thereof to a permanent magnet to be operated in conjunction with the induction coil, and a pressurizing piston having at an open inlet thereof an oil through hole 28e, and having on an outer circumference of an outlet thereof a discharge groove 28c, the pressurizing piston being inserted into the moving spindle 27, wherein oil fed from the inlet of the pressurizing piston 28 passes through the oil through hole 28e and is discharged through the discharge groove 28c, and the moving spindle 27 and the pressurizing piston 28 constrained by the moving spindle 27 are moved to the outlet by a magnetic flux formed according to the electricity applied to the induction coil, thus compressing the oil, and the moving spindle and the pressurizing piston are returned to their original positions by the spring 26 when applied voltage is cut off.

The hollow housing 10 further includes a partition wall provided between the first impeller 15 and the second impeller 15.

The pressurizing piston 28 further includes a streamlined protrusion provided on an inner surface of the outlet side thereof to protrude toward the inlet side thereof, and allowing the inflow oil to smoothly flow when the pressurizing piston 28 moves to an intake side.

The hydraulic control type supercharger further includes a discharge promoter which has a hollow housing 10 inserted into an exhaust pipe and having a longitudinal hollow portion, a rotating shaft 12 mounted to the hollow housing 10 to pass through the hollow portion thereof, an impeller 15 rotating along with the rotating shaft 12, an oil inlet passage 31 and an oil outlet passage defined in the hollow housing 10 to inject oil into the impeller 15 and discharge the injected oil, and a discharge fan rotating along with the rotating shaft 12.

### DESCRIPTION OF DRAWINGS

FIG. 1 is a sectional view showing a conventional turbocharger;

FIG. 2 is a sectional view showing a conventional turbocharger, which was proposed by the inventor of this invention;

FIGS. 3a to 3c are sectional views showing superchargers for engines, according to the first, second, and third embodiments of the present invention;

FIG. 4 is a sectional view of a solenoid pump which is installed in an oil inlet passage and pressurizes oil;

FIGS. 5 and 6 are, respectively, an enlarged sectional view showing the state where a moving spindle of a piston assembly is assembled with a pressurizing piston, and a perspective view showing the pressurizing piston;

FIG. 7 is a view showing the construction of an engine system having the solenoid pump and the supercharger according to the second embodiment of the present invention;

FIG. 8 is a view showing the construction of an engine system having a plurality of solenoid pumps and the supercharger according to the third embodiment of the present invention; and

FIG. 9 is a side sectional view of a discharge promoter which is additionally mounted to an exhaust pipe of the engine so as to smoothly discharge exhaust gas from the engine.

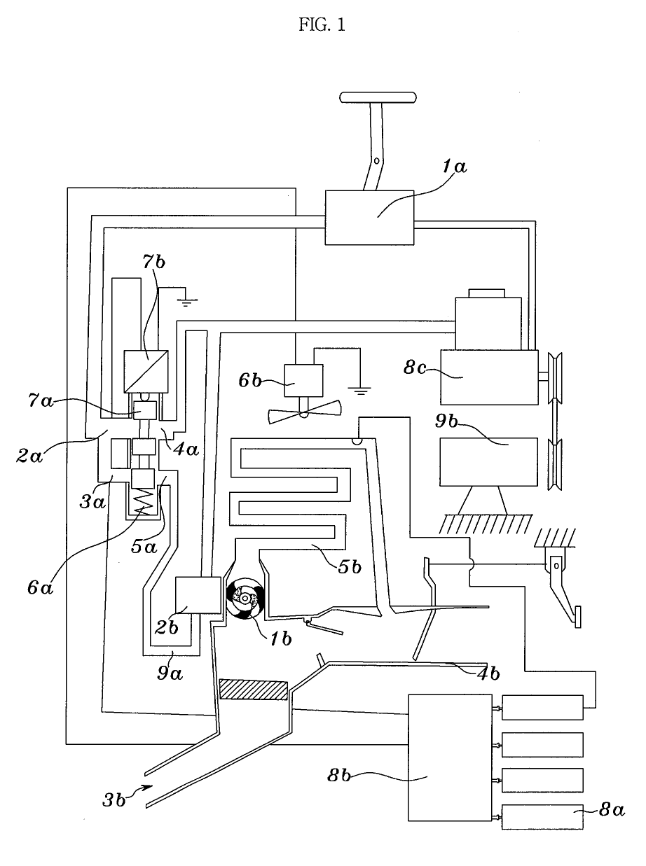

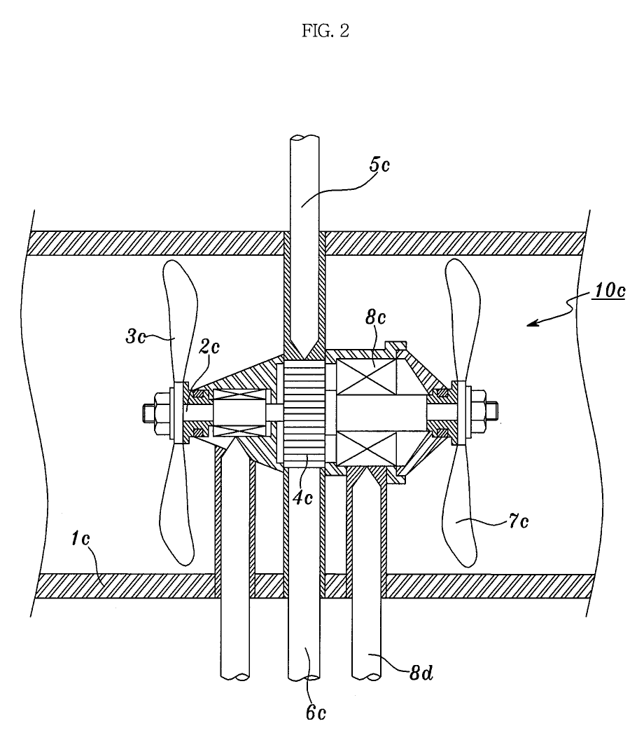

*Description of reference characters of important parts*

| | | | |
|---|---|---|---|
| 100: | supercharger | 200: | solenoid pump |
| 300a: | intake pipe | 300b: | exhaust pipe |
| 400: | engine | 500: | oil pump of engine |
| 600: | oil tank | 700: | control unit |
| 10: | hollow housing | 11: | coupling pipe |
| 12: | rotating shaft | 13: | bearing |
| 14: | intake fan | 15: | impeller |
| 20: | piston assembly | 21: | cylindrical housing |
| 22: | first induction coil | 23: | second induction coil |
| 24, 25: | seat | 26: | spring |
| 27: | moving spindle | 28: | pressurizing piston |
| 31: | oil inlet passage | 33: | oil outlet passage |

### BEST MODE

Hereinafter, the preferred embodiments of the present invention will be described in detail with reference to the accompanying drawings.

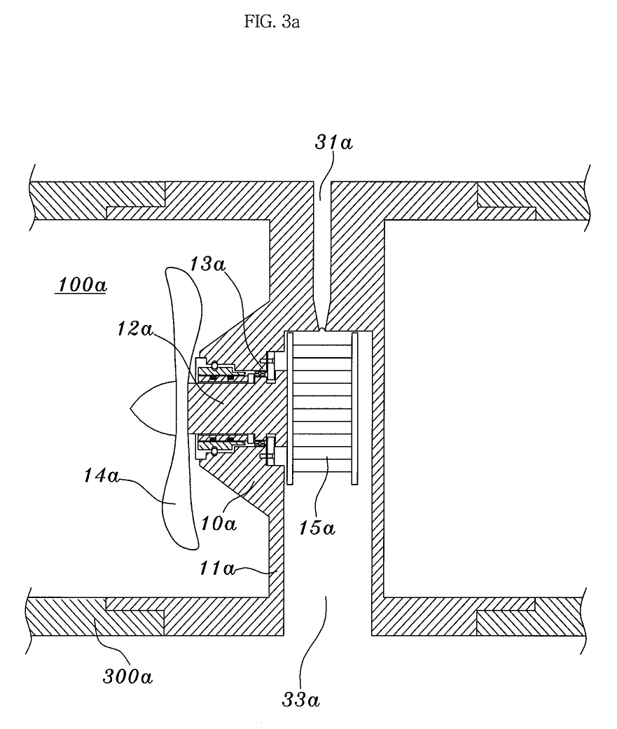

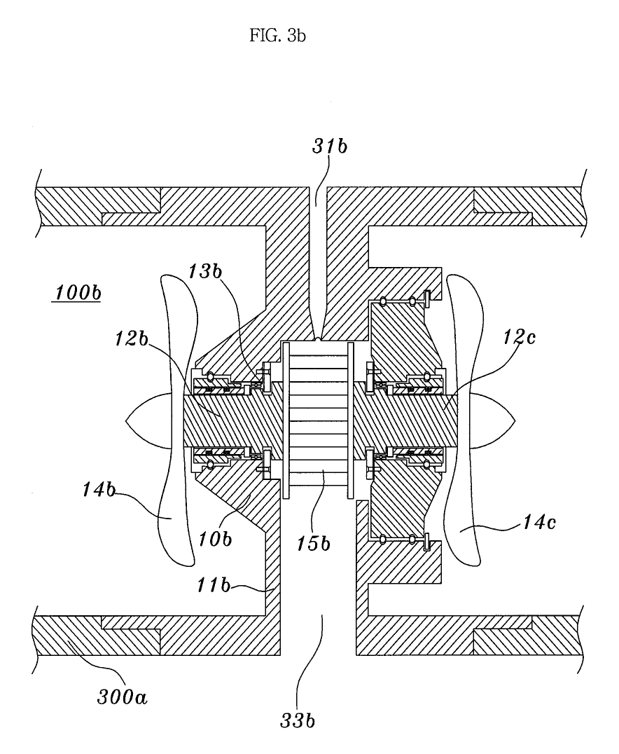

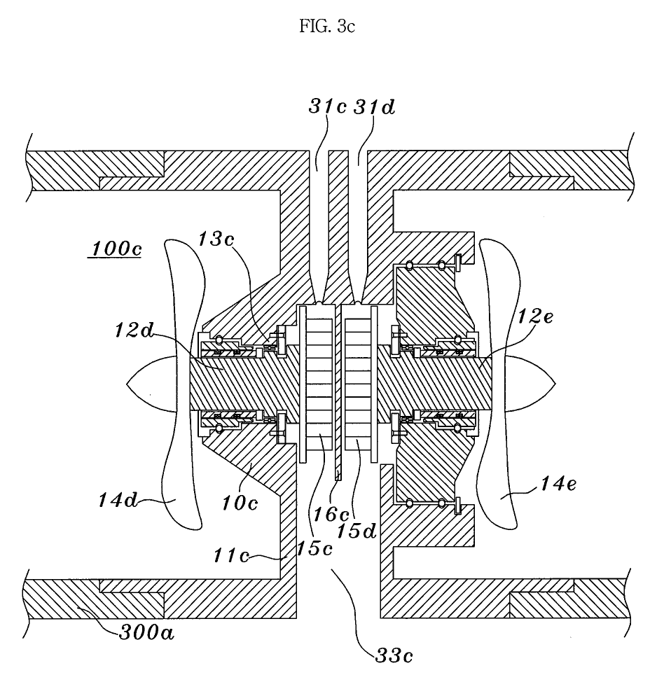

FIG. 3a is a sectional view showing a supercharger 100a for an engine, according to the first embodiment of the present invention.

The supercharger 10a according to the first embodiment is provided with a hollow housing 10a and a coupling pipe 11a. The hollow housing 10a is secured to an intake pipe 300a of the engine. The coupling pipe 11a is coupled to the hollow housing 10a to secure the hollow housing 10a to the intake pipe 300a. An oil inlet passage 31a and an oil outlet passage 33a are defined in the coupling pipe 11a to pass through the hollow housing 10a.

Further, a rotating shaft 12a is inserted into the hollow portion of the hollow housing 10a, and a bearing 13a is provided between the rotating shaft 12a and the hollow housing 10a such that the rotating shaft 12a is rotatable.

An intake fan 14a is mounted to an inlet side of the rotating shaft 12a, and rotates along with the rotating shaft 12a, thus drawing air.

Preferably, one end of the oil inlet passage 31a has the shape of a nozzle so that the pressure energy of introduced oil is converted into kinetic energy, and the oil is sprayed on the impeller 15a at a high speed.

Meanwhile, the rotating shaft 12a is installed to have a predetermined gap between the rotating shaft and the inner surface of the hollow housing 10a, thus ensuring an oil path. Thereby, oil may be fed from the oil inlet passage 31a through the oil path, defined between the rotating shaft 12a and the inner surface of the hollow housing, to the bearing 13a.

Thus, the internal construction of the supercharger 100a for the engine, according to the present invention, is advantageous in that it is not necessary to additionally couple an external oil supply line to the bearing 13a so as to supply oil to the bearing 13a, unlike the prior art.

FIG. 3b is a sectional view showing a supercharger 100b for an engine, according to the second embodiment of the present invention.

The supercharger 100b according to the second embodiment is constructed so that an intake fan 14b and a compression fan 14c are provided on an inlet side and an outlet side of a rotating shaft 12b, respectively. The intake fan rotates along with the rotating shaft 12b so as to draw air. The compression fan compresses the drawn air, prior to discharging the air to the engine. The intake fan and the compression fan are rotated along with the rotating shaft 12b.

Further, the compression fan 14b functions to provide momentum to pressurized air to prevent intake air from flowing backwards when an intake valve operated by a combustion stroke of the engine is opened or closed.

FIG. 3c is a sectional view showing a supercharger 100c for independently driving an intake fan 14c and a compression fan 14c, according to the third embodiment of the present invention.

The supercharger 100c according to the third embodiment is provided with a hollow housing 10c and a coupling pipe 11c. The hollow housing is secured to an intake pipe 300a of the engine. The coupling pipe is coupled to the hollow housing 1c to secure the hollow housing 10c to the intake pipe 300a. First and second oil inlet passages 31c and 31d and an oil outlet passage 33c are provided in the coupling pipe 11c in such a way as to pass through the hollow housing 10c.

Further, a first rotating shaft 12d and a second rotating shaft 12e are provided, respectively, on an inlet side and an outlet side of the hollow housing 10c in such a way as to be spaced apart from the hollow housing. A bearing 13c is provided between the first or second rotating shaft 12d or 12e and the hollow housing 10c.

Further, the intake fan 14d for drawing air is coupled to the inlet side in such a way as to be rotated along with the first rotating shaft 12d. A first impeller 15c is coupled to the outlet side, and converts the kinetic energy of oil injected under high pressure into rotary torque, thus rotating the intake fan 14d via the rotating shaft 12d.

A second impeller 15d and a compression fan 14e are coupled to the inlet side and the outlet side of the second rotating shaft 12e, respectively, such that the second rotating shaft 12e and the first rotating shaft 12d form a bilateral structure.

Meanwhile, the first impeller 15c and the second impeller 15d are oppositely installed to be adjacent to each other, as described above. Thus, when oil is injected, interference between the first and second impellers may occur. That is, when oil is injected from each of the oil inlet passages 31c and 31d, an associated impeller is driven (namely, oil injected from the first oil passage drives the first impeller), and simultaneously, the adjacent impeller is driven together therewith (namely, oil injected from the first oil passage drives the second impeller which is adjacent to the first impeller).

Thus, as shown in the drawing, a partition wall 16c is preferably installed between the first impeller 15c and the second impeller 15d, so that the first impeller 15c and the second impeller 15d are independently driven, thus allowing the operation to be more accurately controlled.

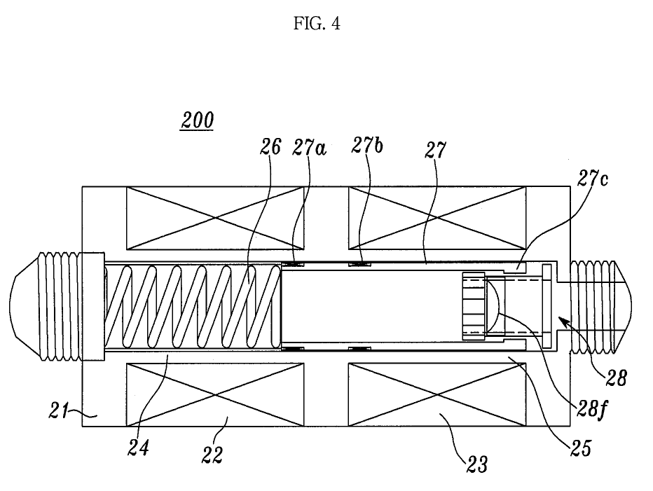

FIG. 4 is a sectional view showing a solenoid pump 200 which is coupled to the oil inlet passage 31 and selectively pressurizes the oil in response to an electric signal.

The solenoid pump 200 includes a hollow cylindrical housing 21 and a piston assembly 20. Seats 24 and 25, each having the shape of a groove, are provided on the cylindrical housing 21 to be spaced apart from each other in a longitudinal direction thereof, so that a first induction coil 22 and a second induction coil 23 are wound around the outer circumferential surface of the cylindrical housing 21. The piston assembly 20 is installed in the cylindrical housing 21.

The piston assembly 20 includes a spring 26, a cylindrical moving spindle 27, and a pressurizing piston 28. The spring 26 is installed in an outlet side of the cylindrical housing 21. The cylindrical moving spindle 27 is elastically supported by the spring 26. The pressurizing piston 28 is inserted into the moving spindle 27.

The moving spindle 27 is manufactured to have the shape of a hollow pipe, thus defining an internal path in which oil flows. The moving spindle 27 is inserted into the cylindrical housing 21 in such a way as to be spaced apart from the inner surface of the cylindrical housing and to move in a longitudinal direction of the cylindrical housing 21.

Further, the moving spindle 27 includes a first permanent magnet 27a and a second permanent magnet 27b, which are provided at the oil outlet side and are provided around the outer circumferential surface of the moving spindle 27. The first permanent magnet 27a is operated in conjunction with the first induction coil 22 of the cylindrical housing 21, and the second permanent magnet 27b is operated in conjunction with the second induction coil 23. A narrow end 27c is provided at the oil inlet side on the moving spindle 27 in such a way that the inner diameter of the narrow end is smaller than the outer diameter thereof.

The pressurizing piston 28 has a streamlined protrusion 28f provided on an inner surface of the outlet side thereof to protrude toward the inlet side thereof, and allowing the inflow oil to smoothly flow when the pressurizing piston 28 moves to an intake side

When electricity is applied to the first induction coil 22 of the cylindrical housing 21 through an electrode (not shown), the first induction coil 22 has a polarity opposite that of the first permanent magnet 27a, and forms a magnetic flux such that attractive force acts between the first induction coil 22 and the first permanent magnet 27a. Conversely, when electricity is applied to the second induction coil 23, the second induction coil 23 has the same polarity as the second permanent magnet 27b. That is, the second induction coil 23 forms a magnetic flux, so that repulsive force acts between the second induction coil 23 and the second permanent magnet 27b.

That is, when electricity is applied to the first or second induction coil 22 or 23, mounted to the cylindrical hollow housing 10, the moving spindle 27 overcomes the elastic force of the spring 26 and is moved to the outlet side by the attractive force or repulsive force acting between the first or second induction coil 22 or 23 and the first or second permanent magnet 27a or 27b. Meanwhile, when electricity applied to the first or second induction coil 22 or 23 is cut off, the moving spindle 27 is moved to the inlet side by the restoring force of the spring 26, and thus returns to its original position.

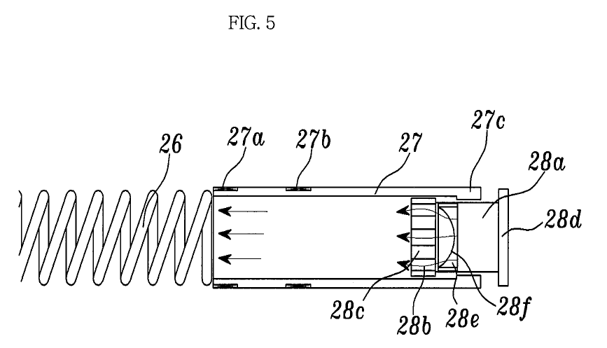

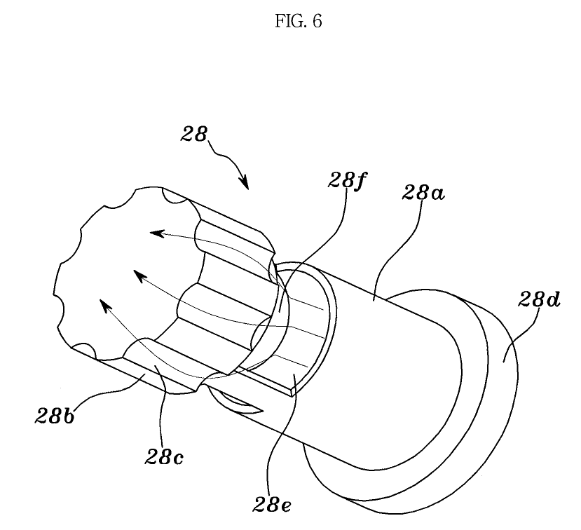

FIGS. 5 and 6 are an enlarged side view showing the state where the moving spindle 27 and the pressurizing piston 28 of the piston assembly 20 are assembled, and a perspective view showing the pressurizing piston 28.

Referring to the drawings, a piston body 28a of the pressurizing piston 28, which is moved by the moving spindle 27 and pressurizes oil, is slidably inserted into the narrow end 27c of the moving spindle 27, which is provided on the inlet side of the moving spindle 27.

Further, a piston head 28b and a piston flange 28d, each having a larger diameter than the piston body 28a, are provided, respectively, on an inlet side and an outlet side of the piston body 28a. The piston head 28b and the piston flange 28d are provided on opposite sides of the narrow end 27c of the moving spindle 27 in such a way as to protrude outwards.

Thus, when the moving spindle 27 moves to the outlet side, the narrow end 27c constrains the piston head 28b, so the pressurizing piston 28 moves to the outlet side. Conversely, when the moving spindle 27 moves to the inlet side, the narrow end 27c constrains the piston flange 28d, so the pressurizing piston 28 moves to the inlet side.

Meanwhile, the inlet side of the piston flange 28d is opened to define a hollow portion into which oil will flow. The outlet side of the piston head 28b is closed to compress the oil.

Further, an oil through hole 28e is formed in the outer circumferential surface of the piston body 28a for oil to flow into and out of the piston body 28a. Discharge grooves 28c, each having a predetermined depth, are formed on the outer circumferential surface of the piston head 28b at regular intervals, thus discharging oil passing through the oil through hole 28e of the piston body 28a.

That is, oil fed into the inlet of the solenoid pump 200 passes through the hollow portion of the piston flange 28d of the pressurizing piston 28 and the oil through hole 28e of the piston body 28a. Next, the oil is discharged to the outlet of the solenoid pump 200 through the discharge grooves 28c of the piston head 28b. Simultaneously, the oil is compressed by the pressurizing piston 28, which is linearly moved by magnetic force induced by voltage applied to the induction coils.

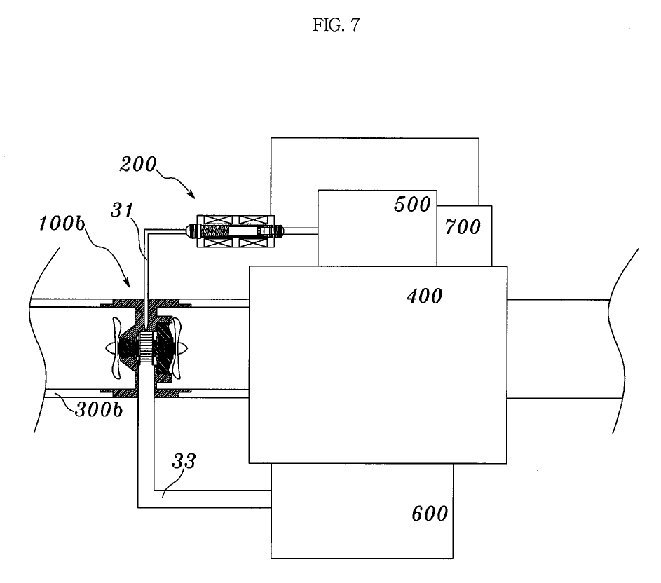

FIG. 7 is a view showing the construction of an engine system equipped with the solenoid pump 200 and the supercharger 100b, according to the second embodiment of the present invention.

As shown in the drawing, the engine system includes an engine 400, an engine oil pump 500 mounted to the engine 400, the solenoid pump 200, the supercharger 100b, an oil tank 600, and a control unit 700. The solenoid pump 200 pressurizes oil fed through a hydraulic line connected to the oil pump of the engine. The supercharger 100b is operated by the compressed oil. The oil tank 600 feeds the oil, discharged from the supercharger 100b, back to the engine 400. The control unit 700 appropriately controls the operation of the solenoid pump 200 according to the output of the engine 400, the vehicle speed, and the acceleration conditions.

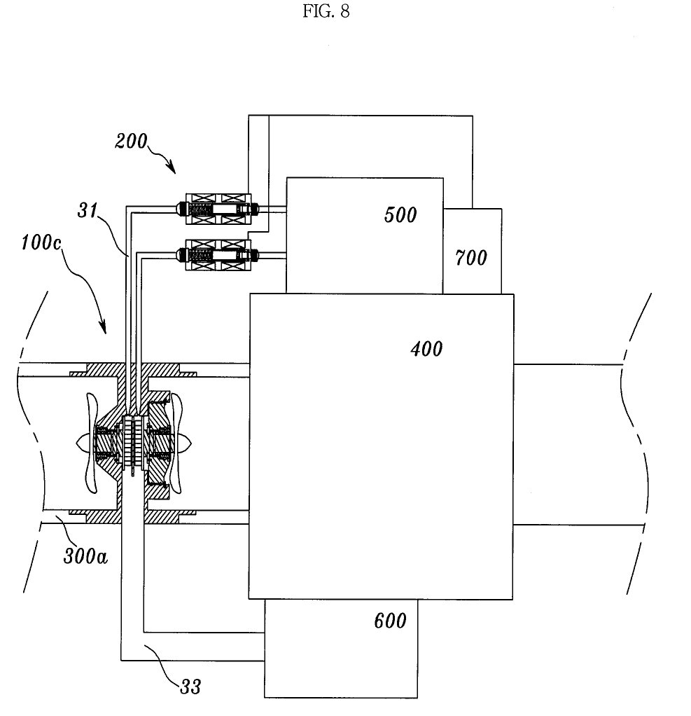

FIG. 8 is a view showing the construction of an engine system equipped with a plurality of solenoid pumps 200 and the supercharger 100c, according to the third embodiment of the present invention.

As shown in the drawing, the hydraulic line includes the first and second oil inlet passages 31c and 31d so as to separately drive the intake fan 14 and the compression fan 14. The solenoid pump 200, controlled electrically, is provided on each of the oil inlet passages, so that the pressure of oil is appropriately controlled according to the RPM of the engine 400 and the acceleration conditions. Thereby, the rotating speeds of the intake fan 14c and the compression fan 14d can be set to have different values.

As a result, it is possible to separately control the intake amount and the compression amount of intake air fed into the engine according to the driving condition of a vehicle, so that the efficiency of the engine 400 can be optimized.

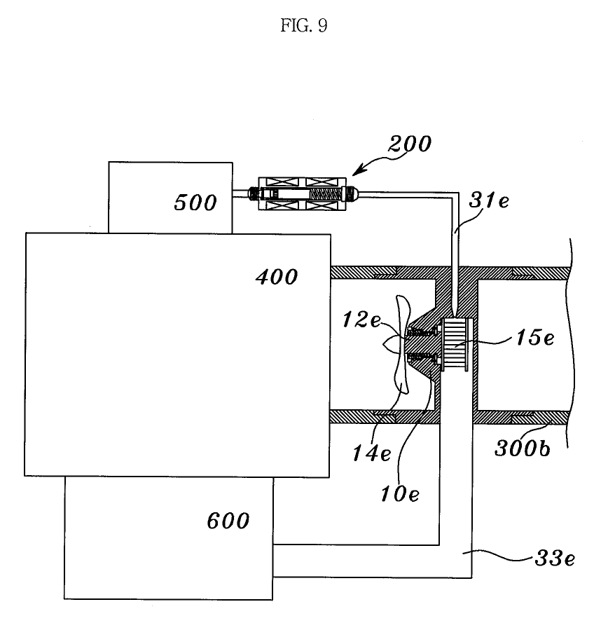

FIG. 9 is a side sectional view showing a discharge promoter 100e, which is additionally mounted to an exhaust pipe of the engine 400 so as to smoothly discharge exhaust gas from the engine 400.

That is, the discharge promoter 100e is additionally mounted to the engine, thus rapidly discharging exhaust gas produced during the combustion stroke of the engine, therefore doubling supercharging performance. The discharge promoter includes a hollow housing 10e, a rotating shaft 12e, an impeller 15e, an oil inlet passage 31e and an oil outlet passage 33e, and a discharge fan 14e. The hollow housing 10e is inserted into the exhaust pipe 300b of the engine, and has a longitudinal hollow portion. The rotating shaft 12e is mounted to the hollow housing 10e to pass through the hollow portion thereof. The impeller 15e rotates along with the rotating shaft 12e. The oil inlet passage 31e and the oil outlet passage 33e are defined in the hollow housing 10e to spray the oil on the impeller 15e and discharge the sprayed oil. The discharge fan 14e rotates along with the rotating shaft 12e.

The following table shows the results of an experiment conducted after the hydraulic control type supercharger for the automotive engine was mounted to an actual vehicle.

| | Engine (400) | | | |
|---|---|---|---|---|
| | RPM | CO (%) | HC (PPM) | NOₓ |
| Before | 970 ± 5 | 0.65/0.67 | 176 | 67 |
| mounting | 1,820 ± 5 | 0.65 | 122 | 16 |
| | 2,900 ± 5 | 4.60 | 201 | 50 |
| After | 970 ± 5 | 0.36 | 137 | 3 |
| mounting | 1,820 ± 5 | 0.19 | 71 | 3 |
| | 2,900 ± 5 | 0.09/0.10 | 29 | 22/23 |

The experiment measured the reduction in smoke in relation to the RPMs of the engine, using small cars produced in Korea. The table shows that the discharged amounts of the harmful substances created by the incomplete combustion of the fuel in the engine, that is, carbon monoxide (CO), unburned hydrocarbons (HC), and nitrogen oxide (NOₓ), were considerably reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a hydraulic control type supercharger for an automotive engine, which does not directly rely on the output of the engine for driving an oil pump but is independently controlled when oil fed into the supercharger is pressurized, thus reducing the consumption of fuel by the engine, improving output, and reducing the discharge of harmful substances.

Further, the present invention provides a hydraulic control type supercharger for an automotive engine, in which an intake fan and a compression fan are separately provided on an inlet side and an outlet side, thus drawing and compressing external air, in addition to preventing the backflow of intake air during the combustion stroke of the engine.

1. A hydraulic control type supercharger for an automotive engine which forcibly blows external air fed into an engine using hydraulic pressure of oil discharged from an oil pump mounted to the engine, the supercharger comprising:
a supercharger unit, comprising:
a hollow housing inserted into an intake pipe and having a longitudinal hollow portion;
a rotating shaft mounted to the hollow housing to pass through the hollow portion thereof;
an impeller rotating along with the rotating shaft;
an oil inlet passage and an oil outlet passage provided in the hollow housing to inject oil into the impeller and discharge the injected oil; and
an intake fan rotating along with the rotating shaft; and
a solenoid pump coupled to the oil inlet passage of the supercharger unit, and operated in response to an electric signal, wherein
operation of the solenoid pump is variably controlled according to driving conditions of a vehicle, and oil, pressurized by the solenoid pump, is injected through the oil inlet passage to rotate the impeller, thus controlling a rotating speed of the intake fan, therefore controlling supercharging performance of the supercharger unit.

2. The hydraulic control type supercharger according to claim 1, further comprising:
a compression fan rotating along with the rotating shaft of the supercharger unit.

3. A hydraulic control type supercharger of an automotive engine which forcibly blows external air fed into an engine using hydraulic pressure of oil discharged from an oil pump mounted to the engine, the supercharger comprising:
a supercharger unit, comprising:
a hollow housing inserted into an intake pipe and having a longitudinal hollow portion;
a first rotating shaft and a second rotating shaft mounted on an upstream side and a downstream side with respect to external air, respectively, to pass through the hollow portion of the hollow housing;
an intake fan and a first impeller mounted to a first end and a second end of the first rotating shaft, respectively;
a second impeller and a compression fan mounted to a first end and a second end of the second rotating shaft, respectively; and
a first oil inlet passage, a second oil inlet passage, and an oil outlet passage provided in the hollow housing for injection of oil to the first and second impellers and discharge of the injected oil; and
a solenoid pump coupled to each of the first oil inlet passage and the second oil inlet passage of the supercharger unit, and operated in response to an electric signal, wherein
operation of the solenoid pump is variably controlled according to driving conditions of a vehicle, and oil, pressurized by the solenoid pump, is injected through the oil inlet passage to rotate the impeller, thus controlling a rotating speed of the intake fan, therefore controlling supercharging performance of the supercharger unit.

4. The hydraulic control type supercharger according to claim 1, wherein
the solenoid pump comprises:
a hollow valve housing around which an induction coil is wound;
a spring installed in the valve housing;
a hollow moving spindle coupled at a side thereof to a permanent magnet to be operated in conjunction with the induction coil; and
a pressurizing piston having at an open inlet thereof an oil through hole, and having on an outer circumference of an outlet thereof a discharge groove, the pressurizing piston being inserted into the moving spindle, wherein
oil fed from the inlet of the pressurizing piston passes through the oil through hole and is discharged through the discharge groove, and the moving spindle and the pressurizing piston constrained by the moving spindle are moved to the outlet by a magnetic flux formed according to the electricity applied to the induction coil, thus compressing the oil, and the moving spindle and the pressurizing piston are returned to their original positions by the spring when applied voltage is cut off.

5. The hydraulic control type supercharger according to claim 3, wherein the hollow housing further comprises:
a partition wall provided between the first impeller and the second impeller.

6. The hydraulic control type supercharger according to claim 4, wherein the pressurizing piston further comprises:
a streamlined protrusion provided on an inner surface of the outlet side thereof to protrude toward the inlet side thereof, and allowing the inflow oil to smoothly flow when the pressurizing piston moves to an intake side.

7. The hydraulic control type supercharger according to claim 1, further comprising:
a discharge promoter, comprising:
a hollow housing inserted into an exhaust pipe and having a longitudinal hollow portion;
a rotating shaft mounted to the hollow housing to pass through the hollow portion thereof;
an impeller rotating along with the rotating shaft;
an oil inlet passage and an oil outlet passage defined in the hollow housing to inject oil into the impeller and discharge the injected oil; and
a discharge fan rotating along with the rotating shaft.

8. The hydraulic control type supercharger according to claim 3, wherein the solenoid pump comprises:
a hollow valve housing around which an induction coil is wound;
a spring installed in the valve housing;
a hollow moving spindle coupled at a side thereof to a permanent magnet to be operated in conjunction with the induction coil; and
a pressurizing piston having at an open inlet thereof an oil through hole, and having on an outer circumference of an outlet thereof a discharge groove, the pressurizing piston being inserted into the moving spindle, wherein
oil fed from the inlet of the pressurizing piston passes through the oil through hole and is discharged through the discharge groove, and the moving spindle and the pressurizing piston constrained by the moving spindle are moved to the outlet by a magnetic flux formed according to the electricity applied to the induction coil, thus compressing the oil, and the moving spindle and the pressurizing piston are returned to their original positions by the spring when applied voltage is cut off.

9. The hydraulic control type supercharger according to claim 3, further comprising:
a discharge promoter, comprising:
a hollow housing inserted into an exhaust pipe and having a longitudinal hollow portion;
a rotating shaft mounted to the hollow housing to pass through the hollow portion thereof;
an impeller rotating along with the rotating shaft;
an oil inlet passage and an oil outlet passage defined in the hollow housing to inject oil into the impeller and discharge the injected oil; and
a discharge fan rotating along with the rotating shaft.
